(19) United States
(12) Patent Application Publication
(10) Pub. No.: US 2026/0303404 A1
(43) Pub. Date: Oct. 1, 2026

(54) COLLECTIVE COMMUNICATION LOW LATENCY PROXY RING OFFLOAD

(71) Applicant: Advanced Micro Devices, Inc., Santa Clara, CA (US)

(72) Inventors: Allen HUBBE, Durham, NC (US); Sarat Babu KAMISETTY, Fremont, CA (US); Brandon K. POTTER, Austin, TX (US); Krishna DODDAPANENI, Cupertino, CA (US)

(21) Appl. No.: 19/093,072

(22) Filed: Mar. 27, 2025

(51) Int. Cl. H04L 12/423; G06F 15/173

(52) U.S. Cl. CPC H04L 12/423; G06F 15/17331

(57) ABSTRACT

A method includes receiving, by a proxy ring included on a network interface controller (NIC), a set of data from a local data processing element (DPE) memory of a local DPE. The NIC includes a proxy ring disposed therein, the remote DPE is external to the NIC, and the local DPE is directly connected to the NIC. The set of data includes data segmented into a plurality data pairings each comprising a portion of the data set and one or more flags that correspond to each portion of the data set that indicate when a corresponding portion of the data set is valid. The proxy ring is polled, by the NIC, and the NIC transmits a plurality of valid data pairings to a remote DPE based on the polling of the proxy ring.

### TECHNICAL FIELD

Examples of the present disclosure generally relate to data processing element (DPE) to DPE communication.

### BACKGROUND

When two or more data process elements (DPEs), such as graphical processing units (GPUs), are located on different servers, one DPE cannot directly post data to another DPE directly. Therefore, a proxy ring buffer (“proxy ring”) is implemented onto the memory of the host. The DPE that is local to the host (i.e., the local DPE) writes the data to be transmitted to the remote DPE to the proxy ring. The host polls the proxy ring and once the to be transmitted data has been successfully posted to the proxy ring, the host transmits the data to a network interface card (NIC) which then transmits the data to the remote DPE via a packet switched network.

### SUMMARY

According to one or more examples, a method includes receiving, by a proxy ring included on a network interface controller (NIC), a set of data from a local data processing element (DPE) memory of a local DPE, the set of data including data segmented into a plurality data pairings each comprising a portion of the data set and one or more flags that correspond to each portion of the data set that indicate when a corresponding portion of the data set is valid, polling, by the NIC, the proxy ring, and transmitting, by the NIC, a plurality of valid data pairings to a remote DPE based on the polling of the proxy ring, wherein the remote DPE is external to the NIC and the local DPE is directly connected to the NIC.

According to one or more embodiments, a system includes a network interface controller (NIC) comprising a NIC memory, a proxy ring included in the NIC memory, the proxy ring configured to receive a set of data segmented into a plurality of data pairings and one or more flags that correspond to each of the data pairings that indicate whether a corresponding data pairing is valid, a pipeline circuitry, and a program stored in the NIC memory to be executed in the pipeline circuitry, the program comprising instructions that cause the pipeline circuitry to: poll, by the NIC, the proxy ring, and transmit a work request to an RDMA engine of the NIC, based on the polling of the proxy ring.

According to one or more examples, a system includes a network interface controller (NIC) including: a NIC memory, a proxy ring included in the NIC memory, the proxy ring configured to receive a set of data segmented into a plurality of data pairings and one or more flags that correspond to each of the data pairings that indicate whether a corresponding data pairing is valid, a pipeline circuitry, and a program stored in the NIC memory to be executed in the pipeline circuitry, the program comprising instructions that cause the pipeline circuitry to: poll, by the NIC, the proxy ring, and transmit a work request to an RDMA engine of the NIC, based on the polling of the proxy ring

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A depicts a system that includes a proxy ring 133 implemented on a network interface controller (NIC), according to one or more examples.

FIG. 1B depicts a system in which an internal central processing unit (CPU) of the NIC is used to poll the proxy ring, according to one or more examples.

FIG. 1C depicts a system in which the NIC includes a pipeline circuitry that is used to poll the proxy ring, according to one or more examples.

FIG. 1D depicts a system in which the NIC includes a pipeline circuitry that is used to poll the proxy ring, according to one or more examples.

FIG. 2 illustrates a method for performing communication between a local DPE and a remote DPE, according to one or more examples.

FIG. 3 illustrates a method for performing direct communication between a local DPE and a remote DPE by polling a proxy ring included in a NIC using an internal CPU of the NIC, according to one or more examples.

FIG. 4 illustrates a method for performing communication between a local DPE and a remote DPE by polling a proxy ring located in a NIC using a pipeline circuitry included on the NIC, according to one or more examples.

FIG. 5 illustrates a method for performing direct communication between a local DPE and a remote DPE by polling a proxy ring using a pipeline circuitry based on an address value receive by a base address register circuitry, according to one or more examples.

FIG. 6 depicts an example DPE, according to one or more examples

To facilitate understanding, identical reference numerals have been used, where possible, to designate identical elements that are common to the figures. It is contemplated that elements of one example may be beneficially incorporated in other examples.

### DETAILED DESCRIPTION

During data process element (DPE) to DPE communication, such graphical processing unit (GPU) to GPU communication, if the DPEs are located on different servers, one DPE cannot post directly into the other DPE. To resolve this issue, a proxy ring buffer is typically implemented onto a memory of the host. The DPE that is local to the memory of the host (i.e., the local DPE) transmits the to be transmitted data to the proxy ring buffer. A processor within the host then polls the proxy ring buffer to determine that the data has been successfully transmitted to the proxy ring buffer. The host then transmits the data from the proxy ring buffer a network interface card (NIC) which transmits the data to the remote DPE using a packet switched network.

However, posting the to be transmitted data to the host instead of directly to the NIC increases the latency of DPE to DPE communication when the DPEs are located on different servers. The host acts as an intermediary between the DPEs and increases the data path between the DPEs. Examples described herein relate to a system in which the proxy ring buffer is implemented on the NIC instead of the host. Advantageously, because the NIC is closer to of the DPEs in the data fabric topology than the host, implementing the proxy ring 133 onto the NIC 116 decreases the latency of DPE to DPE communication.

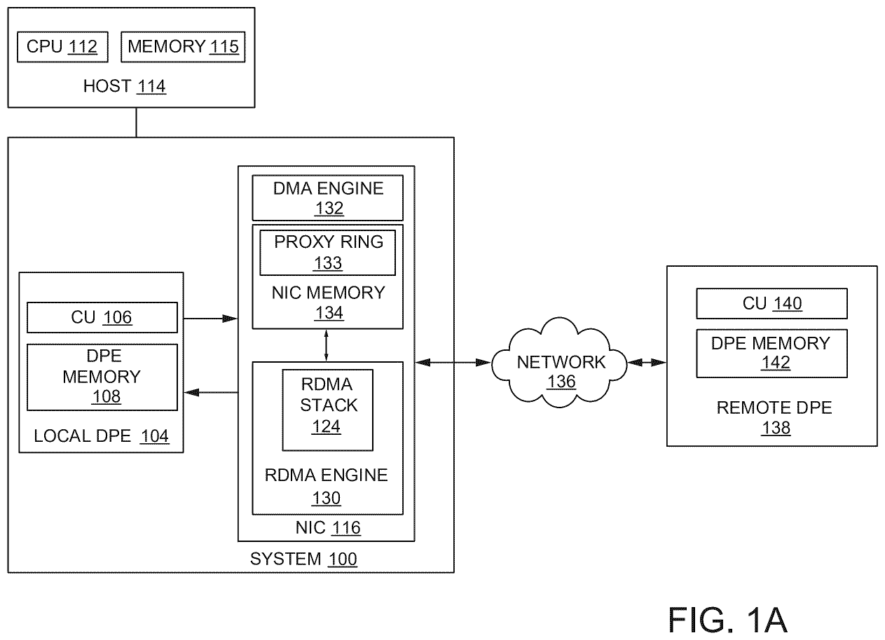

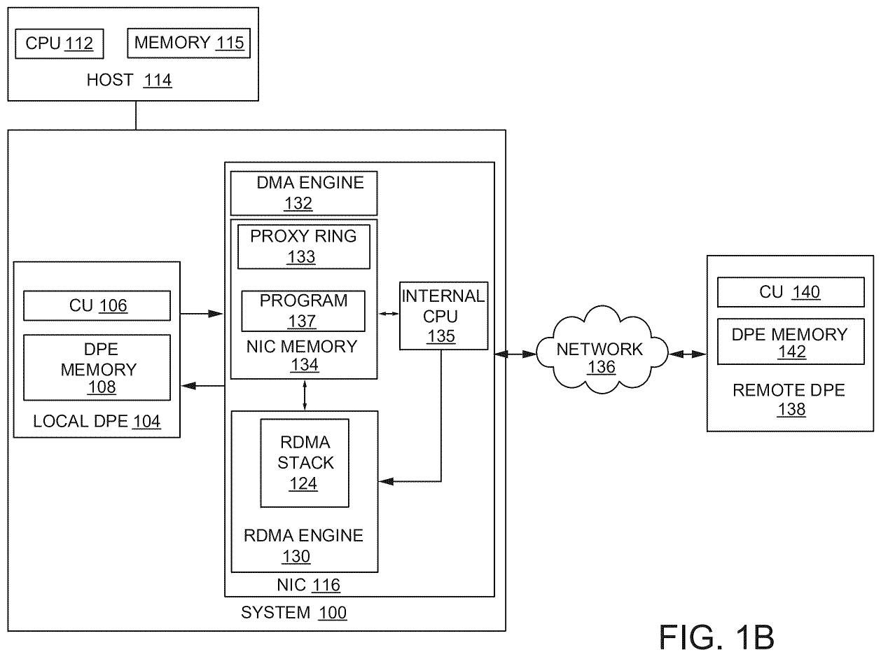

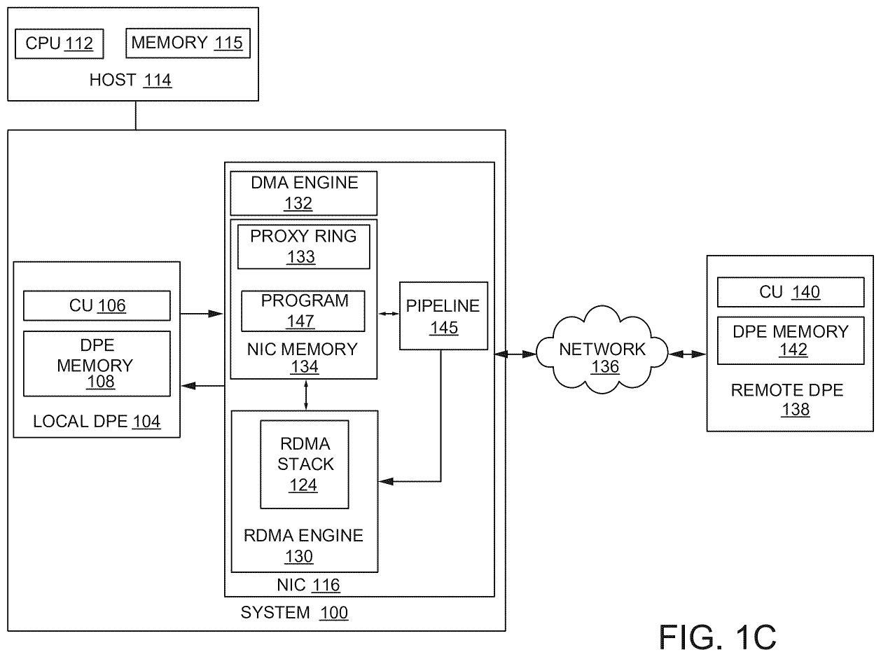

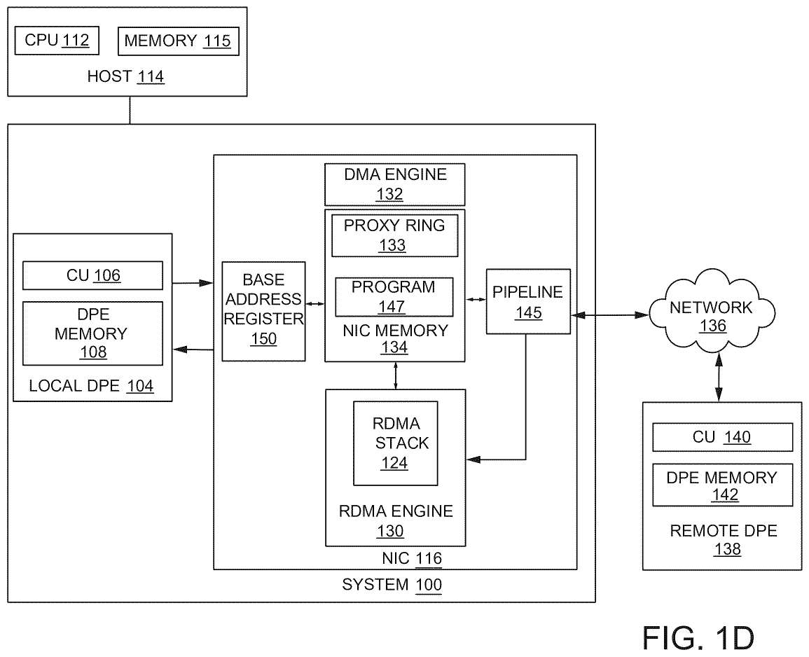

FIG. 1A depicts a system 100 that includes a proxy ring 133 implemented on a network interface controller (NIC) 116, according to one or more examples. The system 100 further includes a local data processing element (DPE) 104 that includes one or more compute units (CUs) 106, and a DPE memory 108. The local DPE 104 may include or represent a graphics processing unit (GPU). The local DPE 104 is not, however, limited to a GPU. The DPE memory 108 may include, for example and without limitation, high-bandwidth memory (HBM). The system 100 may interface with a host 114, which may include a processor, depicted here as a central processing unit (CPU) 112, and a memory 115. In this example, the local DPE 104 may serve as an accelerator for performing (i.e., for offloading) functions of an application program executing on the CPU 112. The system 100 further includes the NIC 116 that interfaces between the local DPE 104 and a packet-switched network 136 (referred to herein “a network 136”). The NIC 116 may communicate (e.g., exchange a set of data) with other devices (e.g., DPEs) via the network 136. The one or more of the other devices may include a remote DPE 138 disclosed in one or more examples herein. Stated differently, the local DPE 104 is directly connected to the NIC 116, whereas the remote DPE 138 is external to the NIC 116.

In one or more examples, the remote DPE 138 that includes one or more CUs 140, and a DPE memory 142. The remote DPE 138 may include or represent a graphics processing unit (GPU). The remote DPE 138 is not, however, limited to a GPU. The DPE memory 142 may include, for example and without limitation, high-bandwidth memory (HBM).

In the example of FIG. 1A, a stack 124 is depicted as a remote direct memory access (RDMA) stack of an RDMA engine 130. The stack 124 is not, however, limited to an RDMA stack. The host 114 may provide setup information to the NIC 116. The host 114 may provide setup information to the RDMA engine 130 to setup queue-pairs with remote systems. A queue-pair is a pair of buffers that are linked through respective RDMA engines for RDMA operations. The NIC 116 may further include a direct memory access (DMA) engine 132 that accesses the DPE memory 108 of the local DPE 104, or a portion thereof, and/or memory of a remote device (i.e., via network 136), such as the DPE memory 142 of the remote DPE 138.

As understood by those with ordinary skill in the art, in DPE (GPU) to DPE communication (e.g., communication from the local DPE 104 to the remote DPE 138) a set of data that is to be transmitted to the remote DPE 138 is written from the DPE memory 108 of the local DPE 104. In one or more examples, the set of data transmitted by the local DPE 104 relates to an operation such as data transfer operations (e.g., send/receive, read/write), and may include remote direct memory data access (RDMA) operations, collective operations (e.g., put, broadcast, scatter, gather, reduce, and/or barrier), atomic operations, and/or other operations.

When the set of data is written from the DPE memory 108, to better achieve a low-latency DPE to DPE communication, the set of data is scheduled (i.e., written) in a piece-wise manner. In one or more examples, the set of data is expanded and segmented into one or more data pairings that each include a portion of the data within set of data and one or more flags that correspond to each portion of data within the set of data. In one example, a data pairing is defined as DF_PAIRING:={DATA, FLAG}, where DATA corresponds to a byte of data within the set of data and FLAG corresponds to one or several bytes of flag(s). In one example, a data paring includes 4 bytes of data (a portion of the data set) and 4 bytes of flag which could be represented {4B DATA, 4B FLAG}. The one or more flag(s) indicate when a corresponding portion of the set of data (i.e., a data pairing) has been successfully written. Each data pairing is not written at the same time. Stated differently, one or more data pairings are written at different times and the flags are used to indicate which data pairings have been successfully written. This will be described in more detail below.

As noted above, when DPEs (GPUs) are located on different serves, DPEs cannot transmit directly to another DPE. To resolve this, a proxy ring buffer (herein referred to as a “proxy ring”) is implemented onto the memory 115 of the host 114. For example, the set of data (i.e., the one or more data pairings) are written from the DPE memory 108 of the local DPE 104 to a proxy ring located in the memory 115 of the host 114. The CPU 112 of the host 114 polls the proxy ring to verify that the one or more data pairings written to the proxy ring were successfully written (i.e., valid) by evaluating the flags. When a multitude of polled flags (i.e., data pairings) return as valid, the CPU 112 of the host 114 will submit a work request to the NIC 116. The NIC 116 then transmits the valid data pairings to the remote DPE 138 via the network 136. In one or more examples, the data pairings transmitted to the remote DPE 138 are in the form of a data packet. The data packet may be any type of data packet used in DPE to DPE communication. For example, the data packet is an RDMA over Converged Ethernet (RoCE) packet. However, as also noted above using the host 114 to proxy DPE to DPE communication increases the data path between DPE, and adds significant latency to the communication. Therefore, examples herein relate to a proxy ring 133 included on in a NIC memory 134 of the NIC 116, as shown in FIG. 1A. Advantageously, the NIC 116 is closer to both the local DPE 104 and the remote DPE 138 in the data fabric topology than the host 114. Implementing the proxy ring 133 onto the NIC 116 decreases the latency of DPE to DPE communication caused by including the proxy ring 133 on the host 114 instead of on the NIC 116.

Stated differently, as illustrated in FIG. 1A, the local DPE 104 writes the data pairings to the proxy ring 133 included in the NIC 116, and the NIC 116 polls the proxy ring 133 (i.e., evaluates the data pairings). The NIC 116 then transmits the data pairings to the remote DPE 138 as the NIC 116 determines the data pairings become valid via the network 136. This is described in more detail below. As understood by those with ordinary skill in the art, the set of data may be expanded and segmented into any suitable quantity of data pairings, and any suitable quantity of proxy rings can be included in the NIC memory 134. Furthermore, one or more sets of data may written to the proxy ring(s) simultaneously.

On the other hand, if an error occurs in writing the data pairings to the proxy ring 133, one or more flags may never become valid. In one or more examples, after a period of time elapses and one or more flags are not validated, the NIC 116 will return an error message to the local DPE 104.

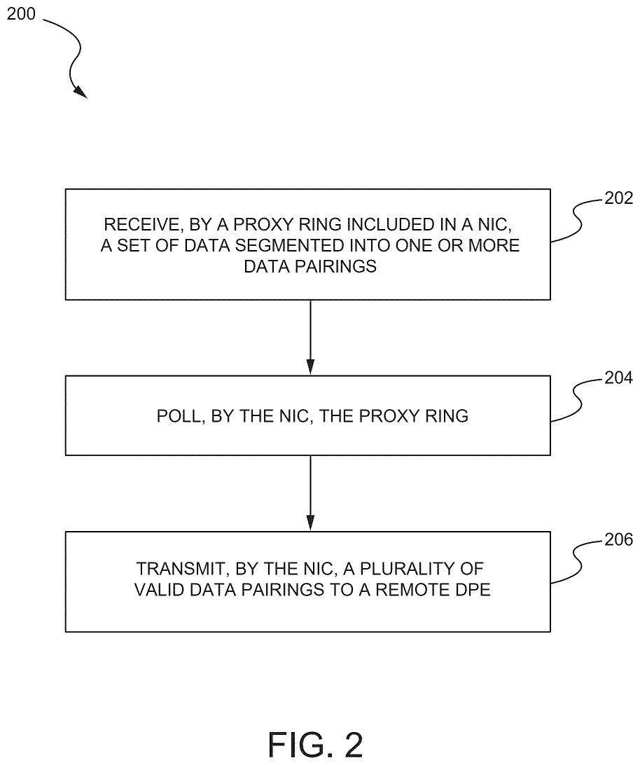

FIG. 2 illustrates a method 200 for performing communication between a local DPE 104 and a remote DPE 138, according to one or more examples. FIG. 2 is described with reference to FIG. 1A.

At operation 202 of the method 200, the proxy ring 133 included in the NIC 116 (i.e., in the NIC memory 134) receives a set of data from the DPE memory 108 of the local DPE 104. As noted above, the set of data relates to an operation such as data transfer operations (e.g., send/receive, read/write), and may include remote direct memory data access (RDMA) operations, collective operations (e.g., put, broadcast, scatter, gather, reduce, and/or barrier), atomic operations, and/or other operations. In one or more examples, if the local DPE 104 has direct access to the NIC 116, the CU 106 writes the set of data to the proxy ring 133. On the other hand, if the local DPE 104 does not have direct access to the NIC 116, the DMA engine 132 fetches the set of data from the DPE memory 108 and writes the set of data to the proxy ring 133. As also noted above, to better achieve low-latency DPE to DPE communication, the set of data is scheduled (i.e., written) to the proxy ring 133 in a piece-wise manner. The set of data is expanded and segmented (by either the CU 106 or the DMA engine 132) into data pairings that each include a portion of the set of data and one or more flags. Stated differently, one or more data pairings are written to the proxy ring at different times that each include a portion of the set of data and one or more flags that are used to indicate when a corresponding portion of data of the set of set data has been successfully written.

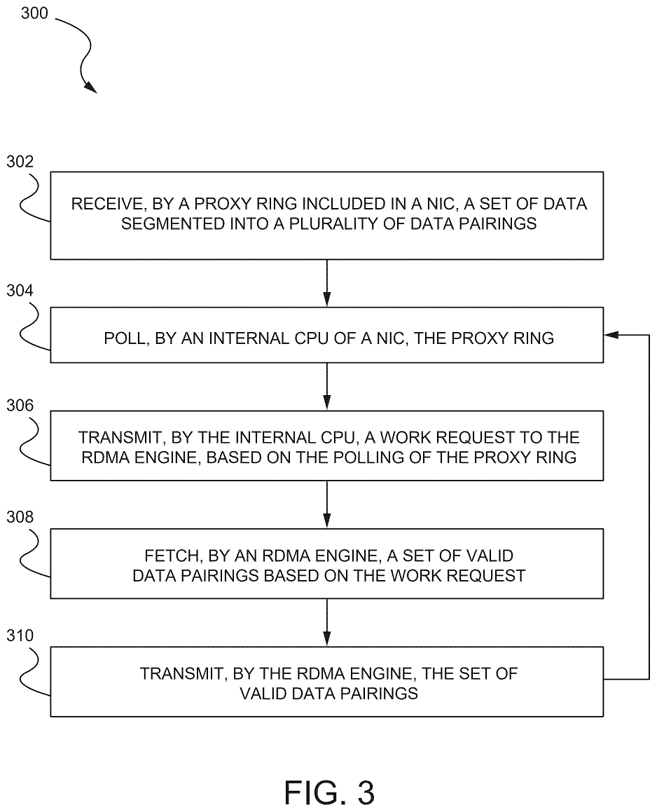

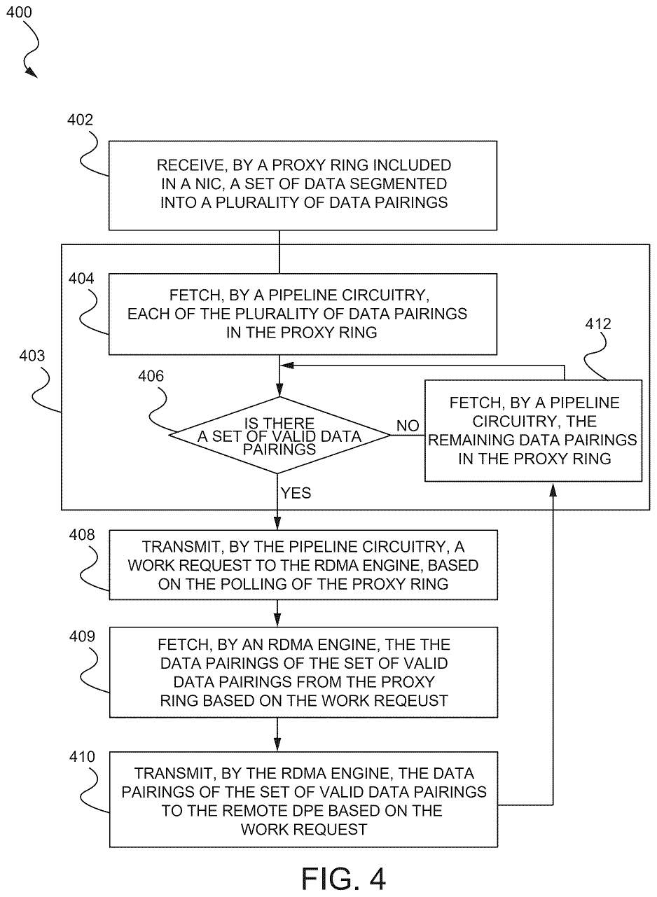

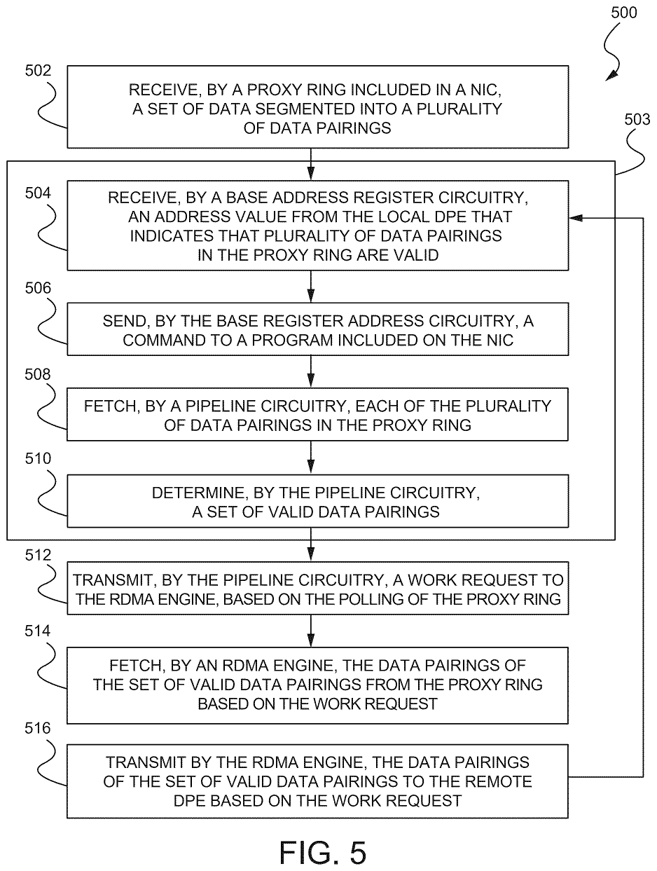

At operation 204 of the method 200, the NIC 116 polls the proxy ring 133. In one or more examples, the NIC 116 polls the proxy ring 133 to determine data pairings that are valid. The NIC 116 determines that a data pairing is successfully written to the proxy ring if the flag(s) within a data pairing equal an expected value (i.e., valid). As will be described in more detail below, the NIC 116 polls the proxy ring 133 using an internal central processing unit (FIG. 1B and FIG. 3) or a pipeline circuitry included in the NIC 116 (FIG. 1C, FIG. 1D, FIG. 4, and FIG. 5).

At operation 206 of the method 200, the NIC 116 transmits the valid data pairings to the remote DPE 138. In one or more examples, the NIC 116 fetches the valid data pairings form the proxy ring 133 and transmits the valid data pairings to the remote DPE 138 via the network 136. This is described in more detail below.

In one or more examples, the NIC 116 repeats operations 204 and 206 until each of the data pairings are transmitted to the proxy ring 133 (i.e., the proxy ring is empty). As will be described in more detail below the RDMA engine 130 of the NIC transmits valid data pairings to the remote DPE 138 based on work requests received by the RDMA engine.

In one or more examples, the NIC 116 is a data processing unit (DPU) that includes an internal CPU. If the NIC 116 is a DPU, a program can be stored on the NIC memory 134 to be executed by the internal CPU that includes instructions that cause the internal CPU to poll the proxy ring and submit work requests to the RDMA engine 130 that cause the RDMA engine 130 to fetch valid data pairings from the proxy ring and transmit the valid data pairings to the remote DPE 138.

FIG. 1B depicts a system 100 in which an internal CPU 135 of the NIC 116 is used to poll the proxy ring 133, according to one or more examples. As noted above, in FIG. 1B, the NIC 116 is a DPU that includes the internal CPU 135. In one or more examples, a program 137 is stored in the NIC memory 134. The program 137 includes instructions that cause the internal CPU 135 to poll the proxy ring 133 to determine whether a plurality of data pairings are valid, transmit a work request to the RDMA engine 130 (i.e., the stack 124) indicating a plurality of data pairings are valid and causes the RDMA engine 130 to fetch the valid plurality of data pairings and transmit the valid data pairings to the remote DPE 138. The internal CPU 135 polls the proxy ring 133 and transmits work requests until each of the data pairings have been transmitted to the remote DPE 138. On the other hand if an error occurs in writing the data pairings to the proxy ring 133, one or more flags may never become valid. Therefore, the internal CPU 135 polls the proxy ring 133 until all of the data pairings are valid (i.e., the proxy ring 133 is empty) or until the internal CPU 135 polls the proxy ring 133 for a time that exceeds a time-out time period. Once the time that the internal CPU 135 polls the proxy ring 133 exceeds the time-out time period, the internal CPU 135 will return an error message to the local DPE 104.

In one or more examples, the program 137 may be any program that is compatible with RDMA technology (i.e., the RDMA engine 130 and the stack 124). For example, the program 137 includes (uses) InfiniBand (IBV) verbs, RDMA over RoCE, or any other RDMA compatible technology that causes the internal CPU 135 to poll the proxy ring 133 and transmit the work requests to the RDMA engine 130.

FIG. 3 illustrates a method 300 for performing direct communication between a local DPE 104 and a remote DPE 138 by polling a proxy ring 133 included in a NIC 116 using an internal CPU 135 of the NIC 116, according to one or more examples. FIG. 3 is described with reference to FIG. 1B.

At operation 302 of the method 300, the proxy ring 133 included in the NIC 116 (i.e., in the NIC memory 134) receives a set of data from the DPE memory 108 of the local DPE 104. In one or more examples, operation 302 is performed in the same manner as operation 202 of the method 200.

At operation 304 of the method 300, the internal CPU 135, polls the proxy ring 133. In one or more examples, operation 304 corresponds to operation 204 of the method 200.

As noted above, the instructions in the program 137 cause the internal CPU 135 to poll the proxy ring 133. The internal CPU 135 polls the proxy by determining whether each of the one or more flags within each of the data pairings are valid (i.e., equal to an expected value). The internal CPU 135 polls the proxy ring 133 by cycling through each of the data pairings in the proxy ring 133 and determining whether there is a set of data pairings in the proxy ring 133. During each polling cycle, each data pairing that is valid is added to the set of valid data pairings. During each polling cycle, the internal CPU 135 updates the set of valid data pairings until a work request is generated. After generating a working request the internal CPU 135 determines and updates a new set of valid data pairings until a subsequent work request is generated. In one or more examples, each set of valid data pairings includes a plurality of data pairings. In other examples, each set of data pairings includes one or more data pairings. A data pairing is valid if the one or more flags within said data pairing is equal to an expected value.

At operation 306 of the method 300, the internal CPU 135 transmits a work request to the RDMA engine 130 based on the polling. Stated differently, the internal CPU 135 transmits the work request after determining a set of valid data pairings (i.e., a plurality of valid data pairings). In one or more examples, the internal CPU 135 transmits the work request to the stack 124 once the set of valid data pairings includes a plurality of data pairings. Therefore, a work request is not generated until the set of valid data pairings includes a plurality of valid data pairings. Stated differently, if the set of valid data pairings does not include a plurality of valid data pairings, the proxy ring 133 is polled (i.e., another polling cycle is performed, as described in operation 304) until a plurality of valid data pairings are included in the set of data pairings. On the other hand, as noted above, the work request can also be generated once the set of valid data pairings includes one or more valid data pairings. The work request instructs to the stack 124 to fetch the data pairings included in the set of valid data pairings and transmit the set of valid data pairings to the remote DPE 138.

At operation 308 of the method 300, based on the work request, the RDMA engine 130 (the stack 124) fetches the data pairing(s) included in the set of valid data pairings from the proxy ring 133.

At operation 310 of the method 300, the RDMA engine 130 (the stack 124) transmits the data pairing(s) included in the set of valid data pairings to the remote DPE 138 based on receipt of the work request. The stack 124 of the RDMA engine 130 transmits the data pairing(s) of the valid set of data pairings to the DPE memory 142.

In one or more examples, the internal CPU 135 repeats operations 304-310 until the each of the data pairings have been transmitted to the DPE memory 142 or the time that the internal CPU 135 polls the proxy ring 133 exceeds the time-out time period. For example, the internal CPU 135 polls the remaining data pairings in the proxy ring 133 until each of the data pairings are included in a work request and are fetched from the proxy ring 133 and transmitted to the DPE memory 142.

In one or more examples, the NIC 116 includes a pipeline circuitry and a program stored in the NIC memory 134 to be executed by the pipeline circuitry. As will be described in more detail below, the pipeline circuitry, via instructions received from the program implemented on the NIC memory 314, causes the pipeline circuitry to poll the proxy ring 133, and submit work requests to the RDMA engine 130 that cause the RDMA engine 130 to fetch valid data pairings from the proxy ring 133 and transmit the valid data pairings to the remote DPE 138.

FIG. 1C depicts a system 100 in which the NIC 116 includes a pipeline circuitry 145 that is used to poll the proxy ring 133, according to one or more examples. In one or more examples, the NIC 116 includes the pipeline circuitry 145. In one or more examples, a program 147 is stored in the NIC memory 134 that is executed by the pipeline circuitry 145. The program 147 causes the pipeline circuitry 145 to poll the proxy ring 133 and send work requests to the RDMA engine 130. Polling the proxy ring 133, initially includes the pipeline circuitry 145 fetching each of the plurality of data pairings included in the proxy ring 133 and determining which (if any) of the plurality of data pairings included in the proxy ring 133 are valid. If the pipeline circuitry 145 determines that each of the plurality of data pairings included in the proxy ring 133 are valid, the pipeline circuitry 145 sends a work request to RDMA engine 130 that causes the RDMA engine (i.e., the stack 124) to fetch each of the plurality of data pairings from the proxy ring 133 and transmit each of the plurality of data pairings to the remote DPE 138 (i.e., DPE memory 142).

On the other hand if only some (and not all) of the plurality of data pairings are valid, the pipeline circuitry 145 sends a work request to RDMA engine 130 that causes the RDMA engine (i.e., the stack 124) to fetch each of the data pairings from the proxy ring 133 that are valid and transmit them to the remote DPE 138. Then, after a back-off time, the pipeline circuitry 145 polls only the data pairings that were not previously valid using the same steps described above (i.e., the data pairings that remain in the proxy ring 133). In one or more example, the back-off time corresponds to the time it takes for the CU 106 to write a data pairing to the proxy ring 133.

In one or more examples, the pipeline circuitry 145 may be any type of pipeline circuitry that can be included in the NIC 116 such a such as a programmable P4 direct memory access (p4dma) pipeline circuitry. The program 147 may be any program that is compatible with the pipeline circuitry 145. For example if the pipeline circuitry 145 is a p4dma pipeline circuitry the program 147 can be a p4plus program.

FIG. 4 illustrates a method 400 for performing communication between a local DPE 104 and a remote DPE 138 by polling a proxy ring 133 located in a NIC 116 using a pipeline circuitry 145 included on the NIC 116, according to one or more examples. FIG. 4 is described with reference to FIG. 1C.

At operation 402 of the method 400, the proxy ring 133 included in the NIC 116 (i.e., in the NIC memory 134) receives a set of data from the DPE memory 108 of the local DPE 104. In one or more examples, operation 402 is performed in the same manner as operation 202 of the method 200.

At operation 403 of the method 400, the pipeline circuitry 145, based on instructions from the program 147, polls the plurality of data pairings in the proxy ring 133. In one or more examples, operation 403 corresponds to operation 204. In one or more examples, operation 403 includes operations 404-406, and operation 412.

At operation 404 of the method 400, the pipeline circuitry 145 fetches each of the plurality of data pairings from the proxy ring 133.

At operation 406 of the method 400, the pipeline circuitry 145 determines whether there is a set of valid data pairings. In one example, a set of valid data pairings exists if a plurality of data pairings within the proxy ring 133 are valid. In other embodiments, a set of valid data pairings exists if at least one of the one or more data pairings within the proxy ring 133 is valid. As noted above, a data pairing is valid if the flags within the data pairing is equal to an expected value.

If the pipeline circuitry 145 determines that there is a set of valid data pairings, the method 400 proceeds to operations 408-410.

At operation 408 of the method 400, the pipeline circuitry 145 transmits a work request to the RDMA engine 130 (the stack 124). In one or more examples, the work request instructs the stack 124 to fetch the set of valid data pairings from the proxy ring 133, and transmit the set of valid data pairings to the remote DPE 138.

At operation 409 of the method 400, based on the work request, the RDMA engine 130 (the stack 124) fetches the data pairings included in the set of valid data pairings from the proxy ring 133.

At operation 410 of the method 400, the RDMA engine 130 (the stack 124) transmits the fetched data pairings included in the set of valid data pairings to the remote DPE 138. The stack 124 of the RDMA engine 130 transmits the data pairings of the valid set of data pairings to the DPE memory 142. After operation 410, the method 400 proceeds to operation 412.

At operation 412 of the method 400, the pipeline circuitry 145 fetches each of the data pairings remaining in the proxy ring 133. In one or more examples, the data pairings that remain in the proxy ring 133 are the data pairings that were not included in the set of valid data pairings, and therefore, were not fetched and transmitted by the RDMA engine 130 during operations 409-410. Stated differently, the pipeline circuitry 145 fetches the data pairings that were not included in the set of valid data pairings. On the other hand, if the set of valid data pairings did not exist at operation 406, each of the plurality of data pairings remain in the proxy ring 133 and are fetched by the pipeline circuitry 145 at operation 412. In one or more examples, the pipeline circuitry 145 fetches each of the data pairings remaining in the proxy ring 133 after the back-off time, and then the pipeline circuitry 145 repeats operations 406-412.

In one or more examples, the pipeline circuitry 145 repeats operations 406-412 until each data pairing of the plurality of data pairings is fetched by the stack 124 from the proxy ring 133. In one or more examples, operation 412 is optional and operations 406-412 are not repeated if at operation 404, all the plurality of data pairings are included in the set of valid data pairings.

In one or more examples, the NIC 116 further includes a base address register circuitry. Advantageously, the base address register circuitry allows the local DPE 104 to inform the pipeline circuitry 145 that data pairings have been successfully written to the proxy ring 133. Therefore, the pipeline circuitry 145 only fetches data pairings from the proxy ring after data pairings have been successfully written to the proxy ring 133.

FIG. 1D depicts a system 100 in which the NIC 116 includes a pipeline circuitry 145 that is used to poll the proxy ring 133, according to one or more examples. As shown in FIG. 1D, the NIC 116 further includes a base address register circuitry 150 disposed therein. In one or more examples, the base address register circuitry 150 is a peripheral component interconnect (PCI) circuitry. As understood by those with ordinary skill in the art, in device to device communication there is a “doorbell” that is a memory mapped input/output (IO) space that exists in the virtual address space of the transmitting device (i.e., the local DPE 104) that maps to physical registers of the receiving device (i.e., the remote DPE 138). The local DPE 104 (using the CU 106) can ring the “doorbell” by writing the address value to the base address register circuitry 150 that is mapped to the physical registers of the receiving device. Stated differently, the local DPE 104 can transmit an address value to the base address register circuitry 150 that indicates that a plurality of valid data pairings have been successfully written to the proxy ring 133 (i.e., rings the “doorbell”). Once the base address register circuitry 150 determines that the address value indicates that a plurality of data pairings have been successfully transmitted, the base address register circuitry 150 transmits a command to the program 147, which causes the program 147 to instruct the pipeline 145 to fetch the plurality of data pairings from the proxy ring 133.

FIG. 5 illustrates a method 500 for performing direct communication between a local DPE 104 and a remote DPE 138 by polling a proxy ring 133 using a pipeline circuitry 145 based on an address value receive by a base address register circuitry 150, according to one or more examples. FIG. 5 is described with reference to FIG. 1D.

At operation 502 of the method 500, the proxy ring 133 included in the NIC 116 (i.e., in the NIC memory 134) receives a set of data from the DPE memory 108 of the local DPE 104. In one or more examples, operation 502 is performed in the same manner as operation 202 of the method 200.

At operation 503 of the method 500, the pipeline circuitry 145, polls each of the plurality of data pairings of the proxy ring 133. In one or more examples, operation 503 corresponds to operation 204. In one or more examples, operation 503 includes operations 504-510.

At operation 504 of the method 500, the base address register circuitry 150 receives an address value from the local DPE 104 that indicates that a plurality of data pairings in the proxy ring are valid (i.e., have been successfully transmitted).

At operation 506 of the method 500, the base address register circuitry 150 sends a command to the program 147 that instructs the program to send instructions to the pipeline circuitry 145 that causes the pipeline circuitry 145 to fetch each of the plurality of data pairings in the proxy ring 133. Stated differently, the base address register circuitry 150 determines that the address value indicates that a plurality of data pairings in the proxy ring 133 are valid and sends a command to the program 147 that instructs the program to send instructions to the pipeline circuitry 145 that causes the pipeline circuitry 145 to fetch each of the plurality of data pairings in the proxy ring 133.

At operation 508 of the method 500, the pipeline circuitry 145 fetches each of the plurality of data pairings from the proxy ring 133.

At operation 510 of the method 500, the pipeline circuitry 145 determines a set of valid data pairings. As noted above, a data pairing is valid if the flags of the data pairing are equal to an expected value. As noted above, the set of data pairings includes a plurality of valid data pairings or one or more valid data pairings. Advantageously, because the local DPE 104 sent the address value to the base address register circuitry 150 indicating that data pairings have been successfully transmitted, there is a guarantee that the pipeline circuitry 145 will determine valid data pairings.

At operation 512 of the method 500, the pipeline circuitry 145 transmits a work request to the RDMA engine 130 (the stack 124). In one or more examples, the work request instructs the stack 124 to fetch the set of valid data pairings from the proxy ring 133, and transmit the set of valid data pairings and their corresponding flags to the remote DPE 138. As noted above, in one example, the work request will not be generated until the set of valid data pairings includes a plurality of data pairings. On the other hand, the work request can be generated so long as the set of valid data pairings includes at least one data pairing.

At operation 514 of the method 500, based on the work request, the RDMA engine 130 (the stack 124) fetches the plurality of valid data pairings included in the set of valid data pairings from the proxy ring 133.

At operation 516 of the method 500, the RDMA engine 130 (the stack 124) transmits the plurality of valid data pairings included in the fetched set of valid data pairings to the remote DPE 138. The stack 124 of the RDMA engine 130 transmits the plurality of valid data pairings within the valid set of data pairings to the DPE memory 142.

After operation 516, the method 500 returns to operation 504. Stated differently, the proxy ring 133 is not polled again until the base address register circuitry 150 receives the address value from the local DPE 104 that indicates that data pairings in the proxy ring 133 are valid. Upon receipt of the address value from the local DPE 104 that indicates that data pairings in the proxy ring 133 are valid, the base address register circuitry 150 sends the command to the program 147 (operation 506), the pipeline circuitry 145 fetches the data pairings (i.e., the remaining data pairings) in the proxy ring (operation 508), the pipeline circuitry 145 determines a set of valid data pairings (operation 510), the pipeline circuitry 145 transmits a work request to the RDMA engine 130 (operation 512), and the RDMA engine 130 fetches the set of valid data pairings from the proxy ring 133 and transmits the set of valid data pairings to the remote DPE 138 (operations 514-516). Stated differently, the pipeline circuitry 145 remains idle until the base address register circuitry 150 receives the address value from the local DPE 104 that indicates that data pairings in the proxy ring are valid.

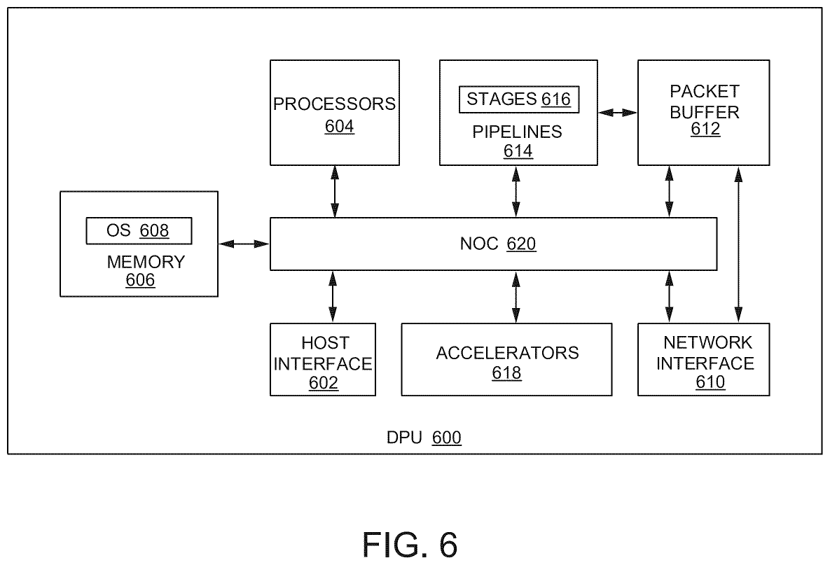

FIG. 6 depicts an example DPE 600 (i.e., local DPE 104 and/or remote DPE 138), according to one or more examples. In the example of FIG. 6, DPE 600 includes a host interface 602 that interfaces with a host (such as host 114). The host may include one or more central processing units (CPUs) and/or graphic processing units (GPUs), and may execute one or more application programs. Host interface 602 may include, for example and without limitation, a peripheral component interconnect express (PCIe) interface and/or other interface type(s).

DPE 600 further includes one or more processors 604, one or more of which may include multiple processing cores. Processors 604 may include CPUs, GPUs, and/or other type(s) of processors. Processors 604 may form one or more CPU core complexes. Processors 604 may include hardware/circuitry that uses an instruction set architecture (ISA) to process data, such as a complex instruction set computer (CISC) and/or reduced instruction set computer (RISC).

DPE 600 further includes memory 606, which may include volatile and/or non-volatile memory such as random access memory (RAM), high bandwidth memory (HBM), and/or other memory. Memory 606 may store an operating system (OS) 608 for execution by processors 604 (i.e., separate from a host OS).

DPE 600 further includes a network interface 610 that interfaces with one or more other network IO systems over a network, such as a packet-switched network and or a NIC (such as NIC 116). Network interface 610 may include an Ethernet interface and/or other interface type(s). DPE 600 may further include a packet buffer 612 that buffers incoming and/or outgoing packets.

DPE 600 may further include packet processing pipelines 614, which may include receive packet processing pipelines that process incoming packets from packet buffer 612, and/or transmit packet processing pipelines that process outgoing packets for transmission by network interface 610. Packet processing pipelines 614 may be programmable (e.g., based on the P4 programming language). Packet processing pipelines 614 may include multiple stages.

Packet processing pipelines 614 or a subset thereof (e.g., receive packet processing pipelines or transmit packet processing pipelines) may operate in parallel with one another. Packet processing pipelines 614 or a subset thereof (e.g., receive packet processing pipelines or transmit packet processing pipelines) may perform the same tasks or differing tasks. As an example, a subset of packet processing pipelines 614 may perform networking tasks, such as combining packets that were subdivided to be compatible with a maximum transmission unit (MTU). Another subset of packet processing pipelines 614 may perform tasks related to the host (e.g., interfacing with a host OS, drivers, and/or message descriptor formats in host memory). Alternatively, or additionally, another subset of packet processing pipelines 614 may serve as direct memory access (DMA) pipelines and/or remote direct memory access (RDMA) pipelines that handle DMA and/or RDMA access requests of the host.

Packet processing pipelines 614 may include multiple stages 616 (e.g., a set of data processing elements connected in series, where the output of one stage serves as the input to a subsequent stage). Stages 616 may perform respective processes on packets or portions thereof (. e.g., packet headers and/or packet payloads). In an example, DPE 600 further includes a parser that parses features of packets, such as packet header vector (PHV), for processing by stages 616 of one or more packet processing pipelines 614. Stages 616 may include circuitry, which may be configurable and/or programmable, such as with the P4 programming language. In an example, stages 616 of multiple packet processing pipelines 614 perform the same functions (e.g., in parallel). Alternatively, or additionally, stages 616 of multiple packet processing pipelines 614 perform differing functions.

Packet processing pipelines 614 and/or stages 616 may include local memory. The local memory may be programmed with local tables (e.g., match-action tables) that indicate whether/how packet processing pipelines 614 and/or stages 616 are to process a packet (e.g., based on features of the packet). In an example, one of stages 616 may perform a lookup operation to read a policy entry in a table to determine whether an entity associated with the packet has exceeded a rate limit (e.g., a packet rate limit and/or a data rate limit).

DPE 600 may further include one or more accelerators 618 that perform specialized tasks, such as data movement tasks. Accelerator(s) 618 may include, for example and without limitation, a cryptography accelerator, a data compression accelerator, an accelerator for performing regex or dedupe, and/or other accelerator type(s).

DPE 600 further include an interconnect, depicted here as a packet-based network-on-chip (NoC) 620 that provides communication links amongst other components of DPE 600. Alternatively, or additionally, the interconnect may include one or more other on-die or on-chip interconnects. In an example, the interconnect further includes direct or dedicated communication links (e.g., AXI interfaces) amongst two or more circuit blocks. In the example of FIG. 6, the interconnect further includes a communication link between packet buffer 612 and network interface 646. In another example, the interconnect includes a link between packet buffer 612 and pipelines 614. Processors 604 and pipelines 614 may communicate with one another via NoC 620.

DPE 600 may further include security and/or management features, which may provide a hardware root of trust, secure boot, and/or other features.

DPE 600 may be configurable as and/or integrated within a network interface controller/card (NIC), such as a SmartNIC, such as to process packets before they are forwarded to the host and/or to process packets for transmission.

DPE 600 may serve as a programmable processor system, which may be useful as an offload engine or accelerator. As an example, DPE 600 may perform functions of, or on behalf of an application program executing on the host, which may free the host to perform other functions of the application program and/or functions of other application programs. DPE 600 may efficiently handle data-centric workloads such as data transfer, reduction, security, compression, analytics, and/or encryption, at scale in data centers. DPE 600 may improve efficiency and performance of data centers by offloading workloads from the host, and may enhance computing power and/or handling of complex data workloads.

As noted above, in current DPE to DPE communication (such as GPU to GPU communication), because a local DPE 104 cannot write directly to a remote DPE 138 a proxy ring is implemented onto the memory 115 of the host 114 and the local DPE 104 provides a plurality of data pairings to the proxy ring on the host 114. The CPU 112 of the host 114 polls the proxy ring to verify that some of the plurality of data pairings written to the proxy ring were successfully written, and the host 114 transmits the valid data pairings to the NIC 116 which then transmits the valid data pairings to the remote DPE 138 via the network 136. Advantageously examples described herein include the proxy ring 133 on the NIC 116. Advantageously, the NIC 116 is closer to both the local DPE 104 and the remote DPE 138 in the data fabric topology than the host 114, and therefore, decreases the latency of DPE to DPE communication.

While the foregoing is directed to specific examples, other and further examples may be devised without departing from the basic scope thereof, and the scope thereof is determined by the claims that follow.

What is claimed is:

1. A method comprising:
receiving, by a proxy ring included on a network interface controller (NIC), a set of data from a local data processing element (DPE) memory of a local DPE, the set of data comprising data segmented into a plurality data pairings each comprising a portion of the data set and one or more flags that correspond to each portion of the data set that indicate when the corresponding portion of the data set is valid;
polling, by the NIC, the proxy ring; and
transmitting, by the NIC, a plurality of valid data pairings to a remote DPE based on the polling of the proxy ring, wherein the remote DPE is external to the NIC and the local DPE is directly connected to the NIC.

2. The method of claim 1, wherein the NIC is a data processing unit (DPU), and polling the proxy ring further comprises:
determining, by an internal central processing unit (CPU) of the NIC, whether each of the one or more flags of each of the plurality of data pairings is equal to an expected value, and
determining, by the internal CPU, a set of valid data pairings, the set of valid data pairings comprising the plurality of valid data pairings, wherein the one or more flags of each of the plurality of valid data pairings are equal to the expected value.

3. The method of claim 2, further comprising transmitting, by the internal CPU, a work request to a remote direct memory access (RDMA) engine of the NIC, wherein the work request instructs the RDMA engine to fetch the set of valid data pairings from the proxy ring and transmit the set of valid data pairings to the remote DPE.

4. The method of claim 3, wherein transmitting, by the NIC, the plurality of valid data pairings to the remote DPE comprises:
fetching, by the RDMA engine, the set of valid data pairings from the proxy ring based on the work request; and
transmitting, by the RDMA engine, the set of valid data pairings to a DPE memory of the remote DPE.

5. The method of claim 1, wherein the NIC further includes a pipeline circuitry included therein, and wherein polling the proxy ring comprises:
fetching, by the pipeline circuitry, the plurality data pairings from the proxy ring; and
determining, by the pipeline circuitry, a first set of valid data pairings, the first set of valid data pairings comprising the plurality of valid data pairings, wherein the one or more flags of each of the plurality of valid data pairings are equal to an expected value.

6. The method of claim 5, wherein polling the proxy ring further comprises:
fetching, by the pipeline circuitry, data pairings within the plurality of data pairings that are not included in the first set of valid data pairings; and
determining a second set of valid data pairings, the second set of valid data pairings comprising valid data pairings within the plurality of data pairings that not included in the first set of valid data pairings.

7. The method of claim 5, further comprising, transmitting by the pipeline circuitry, a work request to a remote direct memory access (RDMA) engine of the NIC, wherein the work request instructs the RDMA engine to fetch the first set of valid data pairings from the proxy ring.

8. The method of claim 7, wherein transmitting, by the NIC, the plurality of valid data pairings to the remote DPE comprises:
fetching, by the RDMA engine, the first set of valid data pairings from the proxy ring based on the work request; and
transmitting, by the RDMA engine, the first set of valid data pairings to a DPE memory of the remote DPE.

9. The method of claim 1, wherein the polling the proxy ring further comprises:
receiving, by a base address register circuitry of the NIC, an address value from the local DPE;
determining, by the base address register circuitry, that the address value indicates that a plurality of valid data pairings are present within the plurality of data pairings;
transmitting, by the base address register circuitry, a command to a program included in a NIC memory of the NIC that is executed by a pipeline circuitry included on the NIC that causes pipeline circuitry to:
fetch, by the pipeline circuitry, the plurality of data pairings from the proxy ring; and
determine a set of valid data pairings, the set of valid data pairings comprising the plurality of valid data pairings, wherein the one or more flags of each of the plurality of valid data pairings are equal to an expected value.

10. A system comprising:
a network interface controller (NIC) comprising:
a NIC memory;
a proxy ring included in the NIC memory, the proxy ring configured to receive a set of data segmented into a plurality of data pairings each comprising a portion of the data set and one or more flags that correspond to each portion of the data set that indicate when the corresponding portion of the data set is valid from a local data processing element (DPE);
an internal central processing unit (CPU); and
a program stored in the NIC memory to be executed in the internal CPU, the program comprising instructions that cause the internal CPU to:
poll the proxy ring; and
transmit a work request to a remote direct memory access (RDMA) engine of the NIC, based on the polling of the proxy ring.

11. The system of claim 10, wherein the instructions to poll the proxy ring comprise instructions that cause the internal CPU to:
determine whether each of the one or more flags corresponding to each of the plurality of data pairings are equal to an expected value, and
determine a set of valid data pairings, the set of valid data pairings comprising a plurality of valid data pairings within the plurality of data pairings, wherein the one or more flags of each of the plurality of valid data pairings are equal to the expected value.

12. The system of claim 10, wherein the work request instructs the RDMA engine to fetch the set of valid data pairings from the proxy ring and transmit the set of valid data pairings to a remote DPE.

13. The system of claim 10, wherein the RDMA engine is configured to:
fetch the set of valid data pairings from the proxy ring based on the work request; and
transmit the set of valid data pairings to a DPE memory of a remote DPE based on the work request.

14. The system of claim 10, wherein the program includes InfiniBand (IBV) verbs.

15. A system comprising:
a network interface controller (NIC) comprising:
a NIC memory;
a proxy ring included in the NIC memory, the proxy ring configured to receive a set of data segmented into a plurality of data pairings and one or more flags that correspond to each of the data pairings that indicate whether a corresponding data pairing is valid;
a pipeline circuitry; and
a program stored in the NIC memory to be executed in the pipeline circuitry, the program comprising instructions that cause the pipeline circuitry to:
poll, the proxy ring; and
transmit a work request to an RDMA engine of the NIC, based on the polling of the proxy ring.

16. The system of claim 15, wherein the instructions to poll the proxy ring cause the pipeline circuitry to:
fetch each of the plurality of data pairings from the proxy ring; and
determine a first set of valid data pairings, the first set of valid data pairings comprising a plurality of valid data pairings within the plurality of data pairings, wherein the one or more flags of each of the plurality of valid data pairings are equal to an expected value.

17. The system of claim 16, wherein the instructions to poll the proxy ring further comprise instructions that cause the pipeline circuitry to:
fetch a plurality of data pairings that are not included in the first set of valid data pairings; and
determine a second set of valid data pairings, the second set of valid data pairings comprising valid data pairings within the plurality of data pairings that not included in the first set of valid data pairings.

18. The system of claim 16, wherein the work request instructs the RDMA engine to fetch the set of valid data pairings from the proxy ring and transmit the set of valid data pairings to a remote DPE.

19. The system of claim 16, wherein the RDMA engine is configured to:
fetch the first set of valid data pairings from the proxy ring based on the work request; and
transmit the first set of valid data pairings to a DPE memory of a remote DPE based on the work request, wherein the remote DPE is external to the NIC.

20. The system of claim 15, wherein the NIC further comprises:
a base address register circuitry configured to send, based on receiving an address value from a local data processing element (DPE) that indicates a plurality of data pairings in the proxy ring are valid, a command to the program that causes the program to send instructions to the pipeline circuitry to poll the proxy ring, wherein the local DPE is directly connected to the NIC, and wherein the instructions to poll the proxy ring cause the pipeline circuitry to:
fetch the plurality of data pairings from the proxy ring; and
determine a set of valid data pairings, the set of valid data pairings comprising a plurality of valid data pairings of the plurality of data pairings, wherein the plurality of valid data pairings are valid if the one or more flags corresponding of each of the plurality of data pairings are equal to an expected value.
